(19) United States
(12) Patent Application Publication
(10) Pub. No.: US 2020/0205633 A1
(43) Pub. Date: Jul. 2, 2020

(54) Arrangement and Method for Contactless Distance Determination of the Type of the Light Intersection Method

(71) Applicant: Fraunhofer-Gesellschaft zur Foerderung der angewandten Forschung e.V., Muenchen (DE)

(72) Inventors: Winfried BAUM, Huefingen (DE); Joshua HAMPP, Kernen (DE)

(21) Appl. No.: 16/614,943

(22) PCT Filed: May 17, 2018
(86) PCT No.: PCT/EP2018/062842

§ 371 Date: Nov. 19, 2019

(30) Foreign Application Priority Data
May 19, 2017 (DE) 10 2017 208 485.5

(51) Int. Cl. A47L 11/40; A47L 9/00; A47L 9/28; G01B 11/02; G01B 11/25; G01S 17/48; G01S 17/931; G05D 1/02

(52) U.S. Cl. CPC A47L 11/4011; A47L 9/009; A47L 9/2805; G01B 11/026; G01C 21/206; G01S 17/48; G01S 17/931; G05D 1/0246; G01B 11/25

(57) ABSTRACT

An arrangement and a method for contactless determination of distance of the type using the light intersection method with at least one light source, a generator for generating a visual contrast line and a light detector.

The generator for generating the visual contrast lens is positioned in a direct sequence and spaced apart from the light source by only air in the beam path of light by the at least one light source between the at least one light source and the means for generating. The means has at least one first edge over which the emitted light passes and through which is projected a shadow of the edge which corresponds to the contrast line which is adjacent an illuminated region which can be projected by the light source. The light detector detects at least the contrast line. The at least one light source, the means for generating and the light detector are positioned on a mobile platform for detecting surroundings surrounding the mobile platform and for autonomous navigation of the mobile platform.

### CROSS REFERENCE TO RELATED APPLICATION

Reference is made to PCT/EP2018/062842 filed May 17, 2018, designating the United States, which claims priority to German Application No. 10 2017 208 485.5 filed May 19, 2017, which are incorporated herein by reference in their entirety

### BACKGROUND OF THE INVENTION

### Field of the Invention

The invention relates to a system and method for contactless distance determination of light using an intersection method with at least one light source, a generator of a visual contrast line and a light detector.

### Description of the Prior Art

For carrying out a contactless two-dimensional determination of distance from objects within surroundings and therefore in association with detecting the contours thereof, the light intersection method is suitable in a manner known per se, which uses a projection system which typically comprises a light source, which preferably is a laser in which a laser beam which is expanded in a fan shape by imaging optics and is projected as a light line onto an object surface to be detected. The light line projected onto the object surface is detected by a position-sensitive light detector, which preferably is a CCD camera, which is positioned to be spatially offset with respect to the light source. From the image of the surroundings obtained with the camera, a light line is extracted and analyzed by an evaluation unit using image evaluation. For this purpose, within a short time interval one camera image is recorded without and another image is recorded with a projected light line from the surroundings. By producing a difference image, brightness differences between the two camera images are retained while image regions of the same brightnesses appear dark. Finally by use of threshold value analysis, the optical light line which appears in high contrast is extracted from the difference image.

As a result of the spatially known offset between light source and light detector, contour-induced deformations are formed along the light line in the detection viewing direction, which reflect a different distance from the object which can be determined exactly by use of the triangulation method. In this way, it is possible to determine the distances between the location points located along the light line and a reference location at which, for example, the measurement arrangement is placed. In this way obtain an exact image of a surface profile of an object along the projected light line is obtained. By way of a relative movement between measurement arrangement and an object onto which the light line is projected, the spatial shape, in the form of a three-dimensional surface profile of an object can be determined.

The application possibilities of such a measurement system which is usually designated as light intersection sensor, are apparent and range from pure distance measurements as far as profile detections and object identifications.

For example, the document DE 10 2012 022 304 A1 describes an arrangement for optical scanning and profilometry using the light intersection method which can be integrated in a microscope system to detect the surface contour of microscopically small objects. The measurement arrangement described has a common objective optic both for the illumination beam path and for the sight path of the light detector.

All the previously known devices in which the light intersection method is used use a specially configured imaging optic to produce and project a light line, which provides for a sharp imaging of the light line on an object surface located in surroundings.

The document DE 10 2010 040 386 A1 discloses a dental x-ray device with an imaging unit for surface detection which superposes a dental tomographic dataset detected with the aid of the x-ray device with a colored height profile of the patient's face with open eyes. The imaging unit required for this has at least one light source which emits a polychromatic light beam which emits over an edge producing a shadow edge so that the shadow edge is projected into the dental region of a person which is additionally recorded using image technology by a dental x-ray device. Furthermore, a detector unit detecting the shadow edge is provided. Finally the color and surface data obtained with the aid of the imaging unit is displayed jointly.

The document DE 23 56 491 A describes an apparatus and a method for determining the geometrical shape of a surface, in particular of a surfaces of items to be welded with a radiation source having beams which illuminate an area to be measured. In the beam path between the radiation source and the surface, a shield is provided to produce a shadow image showing the surface in which the shielding should be arranged geometrically closer to the surface than the radiation source.

Finally the document DE 103 28 537 A1 discloses an apparatus and a method for measuring the dimension of a body in which the surface of the body to be measured is moved along a predefined spatial axis relative to a radiation source which projects a sharp light edge onto the surface of the moving body which is in turn detected by a sensor device and evaluated. In the known apparatus the strictly geometrical arrangements and movement of a body to be measured relative to the measurement arrangement is essential.

### SUMMARY OF THE INVENTION

The invention is based on the objective of providing an system and a method for contactless determination of distance using the light intersection method in such a manner that with the simplest possible and in particular in a cost-effective manner in which a generic determination of distance is possible, which can also be used for the determination of contours or profiles or objects of any type. The invention should in particular be used for the purpose of an autonomous navigation of a mobile platform for a reliable and spatially resolved detection of a scenario surrounding the mobile platform.

In the search for simple and cost-effective solutions which should be possible to carry out distance measurements in a precise manner using the light intersection method, the invention deviates from the usual practice of searching for the most cost-effective individual components for performing the light intersection method. Instead the invention in a new way dispenses with the optics imaging the light beam emitted by the light source. This advance according to the invention is unusual and astonishing when used as an integral part of performing self-navigation. That is autonomously navigating mobile platform for which the detection of the surroundings is of essential importance to provide safe route planning and route control thereof. This is because the generic mobile platforms are fitted with technically high-quality and correspondingly cost-intensive sensors, for example, in the form of laser scanners and similar devices.

An arrangement according to the invention provides for contactless determination of distance using the light intersection method with at least one light source, light generation of a visual contrast line and a light detector, is fundamentally characterized in that the generator for generating the visual contrast line is located in a direct sequence and spaced apart from the light source so that only air is present in the beam path of the emitted light between the at least one light source and the light detector. The generator has an edge over which the emitted light can radiate and through which it is possible to project a shadow of the edge which corresponds to the contrast line which is adjoined by an illuminated region which can be projected by the light source. Thus, the use of a hitherto known refractive or diffractive optics for the focused or sharp imaging of the light emitted by the light source in the form of a projectable light line is expressly eliminated in the arrangement according to the invention. The light detector is suitably configured for the spatially resolved detection of at least the visual contrast line and is arranged spatially at a distance from the light source.

The use of the term “visual contrast line” instead of the term “light line” usually used in this context is therefore based on the fact that the visual contrast line is produced by the edge casting a shadow, which in the shadow line separates the transition from the shadow region to the illuminated region on a projection surface. In contrast, a light line is formed exclusively by projection of a linear light beam on a projection surface.

As also in known generic measurement arrangements, in an exemplary embodiment according to the invention, the at least one light source, the light generator required for generating a light line projection and the light detector are mounted on a common carrier with a fixed spatial arrangement to one another. The at least one light source does not or only weakly emits focused light and preferably is a commercially available light-emitting diode, incandescent lamp or gas discharge lamp. The carrier is arranged on a mobile platform or is part of the chassis of the mobile platform. In this way, it is ensured that the at least one light source, the means and the light detector for detecting a surroundings scenario surrounding the mobile platform are positioned so that the detector signals generated by the light detector can be transmitted indirectly or directly to an evaluation and control unit which is likewise arranged on the mobile platform, which is based on the evaluation and control unit generates control signals which serve to drive and navigate the mobile platform.

Depending on the requirements and intended usage, the light source can emit light having wavelengths in the visible or invisible wavelength range. Such light sources are cost-effective components and therefore are consistent with the desire to achieve the cheapest possible solution for contactless determination of distance of the type using the light intersection method.

The means for generating the visual contrast line which is mounted or arranged at a distance with respect to the at least one light source is preferably a screen made of a material which is non-transparent to the light emitted by the light source and has at least one edge which is preferably configured to be rectilinear and is preferably oriented transversely to the beam direction of the light and is partially radiated over this. The light of the light source is therefore blocked proportionately, for example, half blocked by the screen so that the shadow image of the screen is cast with a linear edge not projecting substantially into the surroundings, such as for example, onto the surface of an object. The shadow edge separates the object region illuminated by the light source from the object region shaded by the screen along the visual contrast line. The light detector, which is configured in the form of a commercially available position-sensitive camera, preferably a CCD or CMOS camera, is mounted offset with respect to the light source outside the spatial region illuminated by the at least one light source on the carrier.

In a simple embodiment, a linkage of the carrier itself serves to generate the visual contrast line, which is not necessarily configured as a screen in the sense of a flat piece extending for example orthogonally in the light path of the light source and only constitutes a housing or carrier edge over which light from the light source can radiate. In this way, the arrangement can be implemented with a minimal expenditure and use of components.

There are no particular requirements for the choice of the light detector required for the arrangement according to the invention. Therefore commercially available and cost-effective position-sensitive light detectors, for example, in the form of CCD or CMOS image sensors, are suitable.

For the evaluation of the images of the surroundings recorded by use of a camera which include the region of the projected visual contrast line, an evaluation unit mounted on the carrier is provided to which the images of the surroundings can be transmitted via a wireless or wired signal line. The evaluation unit comprises a model of the surroundings in which the mobile platform is used. Alternatively or in combination, the evaluation unit can independently generate a model of the surroundings based on the images of the surroundings recorded by the camera and using additional navigation information which, for example is acquired odometrically or by means of an entrained satellite navigation receiving unit. On the basis of a predefinable movement pattern and/or a predefinable movement trajectory and subject to the condition of avoiding collisions with objects located in the surroundings, control signals are generated by a control unit in communication exchange with the evaluation unit, which is preferably configured and arranged as a unit in combination with the evaluation unit, which control signals which serve to drive and navigate, such as steer the mobile platform.

In addition to the already-mentioned rectilinear configuration of the screen edge, in certain cases of application it can be advantageous to structure the screen edge, for example, by embossing a wave or sawtooth profile or corresponding geometrical modifications thereof, so that the edge shadow projected onto at least one object surface located in the surroundings is delimited by a sawtooth-shaped or wave-shaped visual contrast line which is detected by the light detector and is used as a basis for further evaluation for measurement of the distance from the object.

The previously explained generator for generating the visual contrast line in the form of a screen having a rectilinear or structured screen edge over which a suitably shaped visual contrast line can be projected onto the surface of at least one object in the surroundings, makes possible the determination of a distance from spatial points which all lie along the two-dimensional visual contrast line. For each spatial point recorded by the camera, which lies along the visual contrast line and is detected in each case by a pixel or several pixels on the light-sensitive and position-resolving image sensor of the camera, a distance, that is a depth value is determined. The entirety of all the determined depth values forms a spatial curve which describes the contour of the surroundings, such as for example, object contour along the contrast line.

An advantageous further development of the screen with at least one additional second screen edge, the edge profile of which is arranged orthogonally to or inclined with respect to the first screen edge, opens up the possibility of determining the distance points along two preferably orthogonally crossing visual contrast lines which are projected onto an object located in the surroundings, whereby depth information can be obtained in a further direction of extension of the object.

In a further preferred embodiment, two light sources with a spatial offset with respect to one another are arranged so that the visual contrast lines formed in each case by separate illumination of the screen and in particular the screen edge with both light sources are not congruent. For this, it is possible to arrange both light sources with the same distance from the screen in each case and an offset oriented orthogonally to the screen edge. As the further explanations show, in particular the use of two separate light sources serves improves the determination of the distance to be carried out with the system, especially for dispensing with focusing optics according to the invention, is used in generic devices, which has two substantial disadvantages.
1. Since the light source, for example, in the form of an LED, is not punctuate or linear, but has an extension greater than zero, the transition from the illuminated to the shaded object region corresponding to the visual contrast line is not indistinctive, that is the transition is not linear but has a macroscopic width within which the brightness transitions are blurred.
2. As a result of the relatively wide-angle emission behavior of the light source, surrounding objects are not only irradiated directly but partially also indirectly, that is after reflection at other objects.
   In addition, the light emitted by the light source is only shaded by one side of the screen. As a result, a comparatively large amount of scattered light is produced compared with a pure light line projection and an evaluation of the visual contrast line, in particular by way of the initially explained difference image method is permanently influenced.

The two preceding disadvantages inevitably result in a deterioration of the measurement accuracy and the associated sensitivity and reliability of the arrangement for contactless determination of distance based on the light intersection method proposed according to the invention.

Since the blurring of the edge shadow is primarily dependent on the spatial extension of the light source and its distance from the screen casting the shadow, that is the dependence is determined by geometrical variables which are known per se and can be predefined as constant, the blurring manifest in the width of the projected edge shadow is also known. Thus, it is fundamentally possible to minimize the blurring by a suitable choice of these geometrical parameters. This can be achieved by a suitable constructive solution.

On the other hand, the image size of the width of the visual contrast line representing the edge shadow in the light detector, that is in the camera image recorded by the camera, is inversely proportional to the distance to the surroundings object. Therefore, the extent of the blurring, that is the width of the visual contrast line recorded by the camera which corresponds to a certain number of sensor pixels on the sensor side is always the same regardless of the distance between surroundings object and camera position and is therefore also known.

The knowledge of the blurring by which the visual contrast line differs from an ideal line shape and has a width within which a continuous transition from light to dark is provided, is taken as the basis of a correlation method by use of which the exact position of the visual contrast line contained in the camera image is determined for the further evaluation by use of the light intersection method.

Thus, the preceding first disadvantage relating to the blurring can be effectively counteracted both by constructive measures and also computationally, by use of correlation methods.

With the preceding measures, the arrangement according to the invention can already be used successfully in a plurality of cases of usage and in particular in areas in which low-reflecting surrounding objects are present which cause perturbing scattered light when irradiated.

The arrangement according to the invention is therefore already suitable for carrying out the method which is used for contactless determination of distance of the type of the light intersection method and in which a medium illuminated with a light source projects an edge shadow including having an edge characterized by a contrast line to a region directly adjacent to the projected edge shadow and illuminated by the light source. The contrast line is detected by a light detector and is used as the basis for the determination of distance by the light intersection method. In particular, the light emitted by the light source impinges directly, that is exclusively along an air path on the location preferably configured as a screen wherein by radiation passing over the screen, the edge shadow is projected onto an object at a distance from the screen in the surroundings.

In particular in cases in which the ambient light conditions are unfavourably bright, it is possible to use at least two images detected by the light detector as the basis for the light intersection method. The first image reproduces surroundings detected by the light detector in an unilluminated state, that is without light from the light source and the other image representing the surroundings in the illuminated state, that is with the projected edge shadow corresponding to the visual contrast line. Both images are subsequently subjected to a difference image method by operation of the evaluation unit. The result is that image regions having the same or identical brightness values are suppressed during the further evaluation.

However, the preceding measures do not help to avoid the disadvantage mentioned previously under point 2 according to which the scattered light caused by the light emitted from the light source, which is caused by illumination of components of the measurement arrangement itself or in particular of objects in the surroundings, negatively influences the evaluation itself using a difference image method.

In order to also avoid this disadvantage, one embodiment provides instead of a single light source, two light sources arranged spatially offset with respect to one another. The light sources are shaded by one and the same screen or by a screen assigned separately to each of the two light sources. The edge shadows projected by the two light sources into the surroundings are not congruent. To this end, both light sources have a distance which is preferably oriented orthogonally to the screen edge profile.

In order to carry out the method for distance determination, the camera records an image of the surroundings which is illuminated by a first light source and contains an edge shadow which corresponds to a first visual contrast line. Immediately following this, the surroundings are exclusively illuminated by the second light source while the camera records a second image of the surroundings with a corresponding second contrast line. Both recorded images are processed during the course of a difference image method. Since both light sources are placed only slightly offset from one another on the carrier, the influence of the scattered light is almost identical for both individual images so that in the difference image only the narrow region between both visual contrast lines appears light. In this way, the influence of the scattered light can be very strongly reduced.

The evaluation of the difference image obtained in the preceding manner advantageously uses further information which helps to further reduce the discussed blurring problem. As a result of the known spacing of both light sources on the carrier and the known distance thereof from the screen, the distance of the two projected and visual contrast lines with respect to one another is known so that it is easier to distinguish both contrast lines from other light/dark transitions in the image, for example, with textured object surfaces. In this way the reliability of robustness of the correlation method can be improved. Naturally, three or more light sources with respectively different positions on the carrier can also be attached. which are used in the previously explained manner. The camera images which are assigned to the individual exposure situations can be taken as the basis of a difference image method for the further evaluation. Also the use of several light sources which in part have greater geometrical offset with respect to one another enables the recording of several different, that is located further apart, edge shadows on the surface of a surrounding object so that as a result of the evaluation of several visual contrast lines which have macroscopically large spacings from one another, it is possible to make a three-dimensional distance measurement, for example, on an object located in the surroundings.

In addition to the use of camera images for pure distance measurement, as described previously, the arrangement can be used alternatively or in combination for a monitoring function. By attaching the arrangement to a mobile platform, it is possible to record the surroundings within which the platform is put in the position to navigate autonomously. Likewise in this way, mappings of the surroundings can be carried out using the arrangement in this way. In addition, it is feasible to use the arrangement according to the invention for the purposes of pattern recognition of three-dimensional fixed and moving objects. In this context, it is feasible to use the arrangement to identify objects by their 3D geometry.

### BRIEF DESCRIPTION OF THE DRAWINGS

The invention is explained hereinafter without restricting the general inventive idea by reference to exemplary embodiments in the drawings as an example. In the FIGURES:

FIGS. 1a, b, c show a schematic view of embodiments according to the invention.

### DETAILED DESCRIPTION OF THE INVENTION

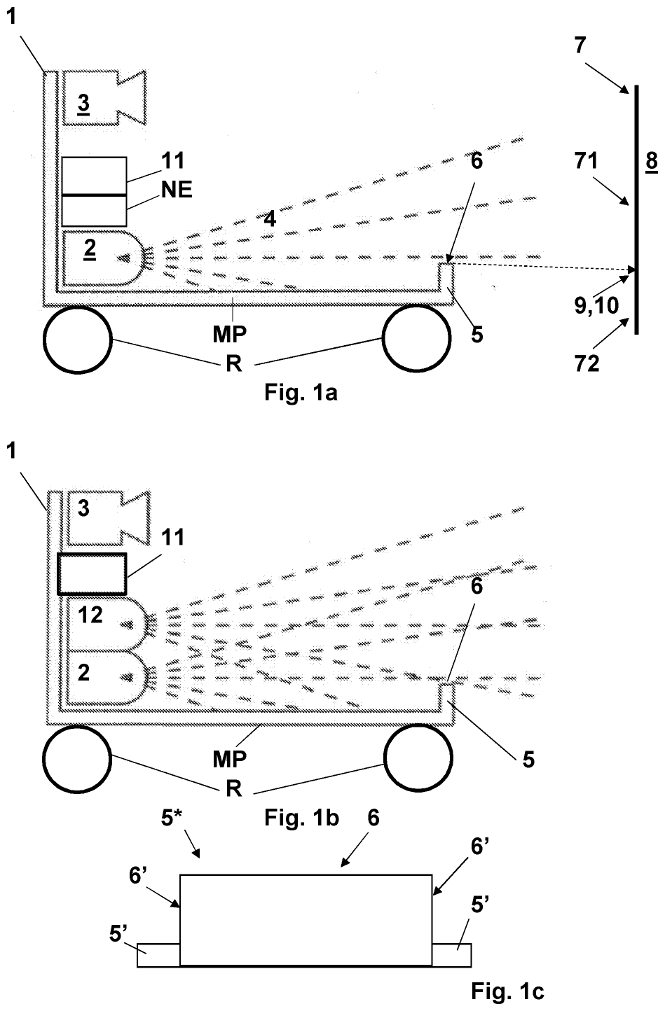

FIG. 1a shows an advantageous embodiment for a contactless determination of distance with a carrier 1 which is part of a chassis of a mobile platform MP on which a light source 2 and a light detector 3 are mounted. The light source 2 emits divergent light 4. A screen 5, which is likewise mounted firmly on the carrier 1, is mounted at a distance from the light source 2. The light 4 of the light source 2 radiates over the screen 5 which has a rectilinear screen edge 6 which projects an edge shadow 9 on the surface of an object 8 located in the surroundings. The edge shadow 9 separates a surface region 71 irradiated by the light source 2 from a surface region 72 shaded by the screen 5. The light detector 3 detects the object 8 and in particular the edge shadow 9 which for the further evaluation corresponds to the visual contrast line 10 which forms the basis of the light intersection method. The camera image which is to be evaluated for the purpose of determining the distance from the object 8, which is recorded from the side of the light detector 3 is evaluated within the framework of an evaluation unit 11 which is in communication with the light detector 3 in a wired or wireless manner. Within the framework of the evaluation unit 11, the camera images are evaluated based on pre-definable and/or independently generated information relating to the surroundings in which the mobile platform MP advances. Under the condition of a collision-free autonomous advance of the mobile platform MB, control signals for the drive and for steering the wheels R are generated by a control unit combined with an evaluation unit 11. Optionally a navigation signal receiver NE is mounted on the mobile platform MB for navigation assistance, which receives signals which can be fed to the evaluation unit 11.

FIG. 1b shows an extended embodiment in which, in addition to the light source 2 according to FIG. 1a, a second light source 12 is mounted on the carrier 1. In the diagram according to FIG. 1b, the second light source 12 is mounted with a minimal distance vertically above the first light source 2 so that the light emitted in each case by both light sources can generate largely identical scattered light components within the surroundings of the arrangement. Reference is made to the preceding explanations for carrying out a different image method using two light sources 2, 12.

Both previously explained exemplary embodiments for the configuration of respectively one mobile platform can advantageously be provided with a screen 5* illustrated in FIG. 1c which is shown in a frontal view contrary to the overradiation direction. The modified screen 5* has, in addition to the horizontally oriented screen edge 6, a screen section 5′ with at least one screen edge 6′ oriented orthogonally to the screen edge 6.

The provision of the modified screen 5* proves to be particularly advantageous when the mobile robot unit is configured as a floor cleaning robot whose task is the cleaning of floor surfaces. In particular, when cleaning floor sections near walls, a predefinably small distance between mobile platform and the wall must be maintained. This is made difficult by the provision of floor skirting boards, whose existence and dimensions can be detected exactly by an additional vertical shadow edge profile caused by the screen edge 6′. The additional vertical shadow edge profile also assists the independent identification of floor-standing objects such as, for example a charging station via which the mobile platform can be independently supplied with electrical energy.

The provision of a light detector 3 in the form of a camera not only enables the spatially resolved detection of at least one shadow edge but also permits, if required, the detection and transmission of the camera image in the form of a video image for the purpose of at least one of an optical monitoring and inspection of the entire surroundings scenario. For this purpose, the entrained light sources can be specifically used as scene lighting. Also by use of such an imaging of the surroundings scenario, it is possible to estimate relating to the location and orientation within the surroundings on the principle of odometry. In addition, the image or video information detected using the camera can be used for targeted navigation of the mobile platform relative to landmarks or illumination patterns located in the surroundings using pattern-recognition image evaluation software.

### REFERENCE LIST

1 Carrier
2 Light source
3 Light detector
4 Light
5 Screen
5* Modified screen
5′ Screen section
6,6′ Edge, screen edge
7 Object surface
8 Object
71 Illuminated object surface region
72 Shaded object surface region
9 Edge shadow
10 Visual contrast line
11 Evaluation unit
12 Second light source
MP Mobile platform
NE Navigation signal receiving unit
R Wheel

1.-15. (canceled)

16. A system for contactless determination of distance by use of a light intersection method comprising:
at least one light source, a means for generating a visual contrast line and a light detector, the means for generating a contrast line is positioned in a direct sequence and spaced apart from the light source, only air is present in a beam path of light from the at least one light source between the at least one light source and the means for generating a visual contrast line, the means for generating the contrast line has at least one first edge over which the emitted light radiates and by which a shadow of the edge is projected which corresponds to the contrast line which is adjacent to an illuminated region projected by the light source, and the light detector detects at least the contrast line and at least one light source, the means for generating a visual contrast line and the light detector are positioned on a mobile platform for detecting surroundings of the mobile platform for providing autonomous navigation of the mobile platform.

17. The system according to claim 16, wherein the at least one light source, the means for generating a visual contrast light line and the light detector are fixedly arranged on a carrier and have a fixed spatial assignment to one another.

18. The system according to claim 16, wherein the means for generating a visual contrast line is a screen which is non-transparent to the light and at least a first edge of the means for generating is rectilinear or structured.

19. The system according to claim 17, wherein the means for generating a visual contrast line is a screen which is non-transparent to the light and at least a first edge of the means for generating is rectilinear or structured.

20. The system according to claim 18, wherein the means for generating a visual line has at least one second edge over which the emitted light radiates, which is orthogonal or inclined with respect to the first edge.

21. The system according to claim 16, wherein two light sources are disposed relative to one another with a spatial offset so that the contrast lines which are formed by separate illumination of the means for generating a visual contrast line with two light sources are not congruent.

22. The system according to claim 16, wherein the at least one light source is an LED, incandescent lamp or gas discharge lamp.

23. The system according to claim 16, comprising an evaluation unit connected at least to the light detector via a wireless or wired signal line to evaluate light signals detected by the light detector for the purpose of determining the distance from the projected contrast line.

24. The system according to claim 16, wherein the light detector transmits signals when light is detected to an evaluation and a control unit disposed on the mobile platform, and the evaluation and control unit generates control signals based on signals from the detector which are used to drive and navigate the mobile platform.

25. The arrangement according to claim 24, wherein the evaluation and control unit generates the control signals based on at least one of a predefined surroundings model and a surroundings model generated by the system.

26. The system according to claim 16, wherein the mobile platform is configured as a floor cleaning robot.

27. A method use of the system according to claim 16 performing pattern recognition of three-dimensional fixed or moving objects.

28. A method for contactless distance determination using light intersection method in which a means for generating is illuminated with a light source which projects an edge shadow with a first edge including a contrast line to a region directly adjacent the projected edge shadow, which is illuminated by the light source, comprising detecting the contrast line by a light detector, using a light intersection method to determine the distance; and detecting surroundings around a platform used for autonomous navigation thereof, on which the light source, the means for generating the contrast line and the light detector are positioned.

29. The method according to claim 28, wherein the light emitted by the light source impinges directly, along an air path, on the means for generating the contrast line and partially emits over the means for generating and projects an edge shadow onto an object spaced apart from the means for generating the contrast line in the surroundings.

30. The method according to claim 28, comprising detecting at least two images by use of the light detector which are detected based on the light intersection method, with one image depicting surroundings in an unilluminated state, that is not illuminated with light from the light source and the other image depicts the surroundings in an unilluminated state, with the contrast line and both images are evaluated by way of a difference image method.

31. The method according to claim 28, wherein the light intersection method uses at least two images detected by the light detector, with one image depicting the surroundings in a state illuminated by a first light source with a first contrast line and the second image depicts the surroundings in a state illuminated by a second light source with a second contrast line, wherein both light sources are spatially separated by a distance from one another and are arranged with the first and second contrast lines being oriented with a predefined spacing with respect to one another and both images are evaluated by use of a difference image method.
